(19) United States
(12) Patent Application Publication
(10) Pub. No.: US 2002/0005845 A1
(43) Pub. Date: Jan. 17, 2002

(54) Display device and portable device provided with the display device

(75) Inventors: Takashi Kondo, Osaka (JP); Hideo Hotomi, Osaka (JP); Katsuhiko Asai, Osaka (JP)

Correspondence Address: MCDERMOTT, WILL & EMERY, 600 13th Street, N.W., Washington, DC, 20005-3096, US

(73) Assignee: MINOLTA CO., LTD.

(21) Appl. No.: 09/892,644

(22) Filed: Jun. 28, 2001

(30) Foreign Application Priority Data
Jun. 28, 2000 (JP) 2000-194322

(51) Int. Cl. G09G 5/00

(52) U.S. Cl. 345/204

(57) ABSTRACT

A plurality of information memories for storing information relating to a various types of functions separately for each function, the plurality of information memories including information memories updateable by input from a communicaiton interface, e.g., memory chips 20-1, 20-2, 20-3, 20-4, and an updater such as a CPU 10 for updating the information, display, and display controller for displaying a composite image on the display 11 based on information relating to various types of functions, and specific formats. A display which has memory function such as a Chiral Nematic liquid crystal may be used as the display 11.

This application is based on Patent Application No. 2000-194322 filed in Japan, the content of which is hereby incorporated by reference.

### BACKGROUND OF THE INVENTION

1. Field of the Invention

The present invention relates to a portable device such as an IC card, mobile phone or the like, and a display device ideally suited for a portable device.

2. Description of the Related Art

Integrated circuit (IC) cards, e.g., information cards storing information such as digital cash or digital money, phone cards and the like have recently become popular. In particular, there are many information cards containing information which is frequently updated through external communication as in the case of remainder information in digital cash functions.

Current information cards store only information relating to a single function, such that only information relating to that function is displayed in a prescribed display format. In a construction which only stores information relating to a single function and only displays information relating to that function in a prescribed format, a plurality of information cards having separate functions must be carried in order to confirm information relating to a variety of functions, an such an arrangement is inconvenient in regard to both portability and operability.

### SUMMARY OF THE INVENTION

An object of the present invention is to provide a display device having excellent portability, convenience, and operability, and further provide a portable device provided with such display device. The display device is capable of simultaneously displaying various types of information relating to a plurality of functions.

Another object of the present invention is to provide a display device having excellent portability, convenience, and operability and further provide a portable device provided with such display device. The display device is capable of displaying, in various formats, various types of information relating to a plurality of functions.

In order to attain the above object, one aspect of the present invention is a display device or a portable device having a plurality of information memories for storing information relating to each type of function separately for each function, and including one or more memory updateable by information input via communication with an external device, an updater for updating the information, a display, and a display controller for displaying composite images on the display based on the prescribed format and the information stored in the information memory.

In this way the information of a plurality of functions can be simultaneously viewed on a single screen.

In order to attain the above object, another Aspect of the present invention is a display device or a portable device having a plurality of information memories for storing information relating to each type of function separately for each function, and including one or more memory updateable by information input via communication with an external device, an updater for updating the information, a display, a format storage for storing a plurality of display formats specified by a user, and a display controller for generating a display image based on current information and a selected display format, and displaying the image on the display.

In this way the information of a plurality of functions can be viewed as desired or by selecting a display format suited to the information.

In addition, the display device and the portable device further includes a power source for supplying power to each part of the device, and a power controller for stopping power supply after a display operation by the display controller, and wherein the display itself has a memory function.

These and other objects, advantages and features of the invention will become apparent from the following description thereof taken in conjunction with the accompanying drawings, which illustrate specific embodiments of the invention.

### BRIEF DESCRIPTION OF THE DRAWINGS

In the following description, like parts are designated by like reference numbers throughout the several drawings.

FIG. 1 is a perspective view of an IC card which is an embodiment of the present invention;

FIG. 2 is a perspective view of a mobile phone which is another embodiment of the present invention;

FIG. 3 shows examples of the displays in FIGS. 1 and 2;

FIG. 4 is a block diagram of the circuit in FIGS. 1 and 2;

FIG. 5 is a flow chart showing the display switching sequence in FIGS. 1 and 2;

FIG. 6 is a flow chart showing the display updating sequence in FIGS. 1 and 2;

FIG. 7 is a flow chart showing the communicaiton control sequence in FIGS. 1 and 2;

FIG. 8 shows a display example in another embodiment of the present invention;

FIG. 9 is a flow chart showing the display switching sequence in FIG. 8;

FIG. 10 is a flow chart showing the display updating sequence in FIG. 8; and

FIG. 11 is a flow chart showing the timer interrupt sequence in FIGS. 1 and 2.

### DETAILED DESCRIPTION OF THE PREFERRED EMBODIMENTS

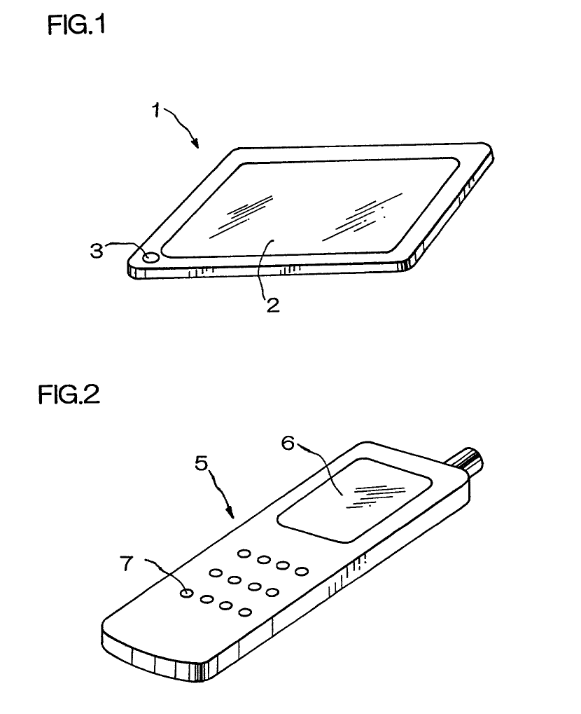

The portable device shown in FIG. 1 is a multifunction composite display type IC card 1 provided with a display screen 2 and display selection operation button 3. The IC card 1 switches displayed contents of the display screen and various other operation using the operation button 3. The display screen 2 of the IC card 1 displays various types of information relating to a plurality of functions based on a selected format.

The portable device shown in FIG. 2 is a mobile phone or portable phone 5 provided with a display screen 6, plurality of keys 7, and operation switching button and the like.

In addition to normal telephone functions, the mobile phone 5 is provided with the identical functions of the IC card 1, and is capable of displaying various types of information relating to a plurality of functions in various selected formats on the display screen 6 based on key operation.

In the description below, both the IC card 1 and the mobile phone 5 are referred to as “portable device.”

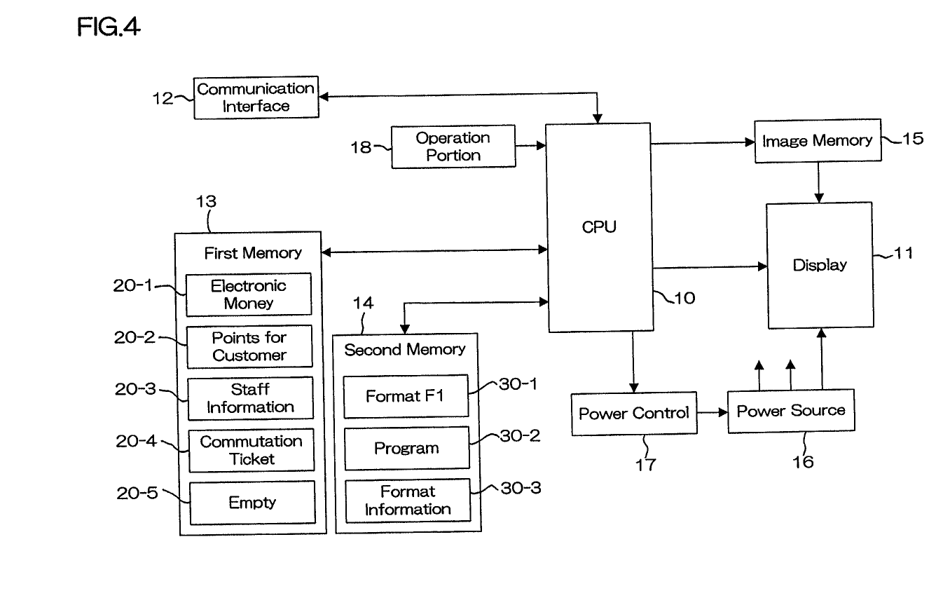

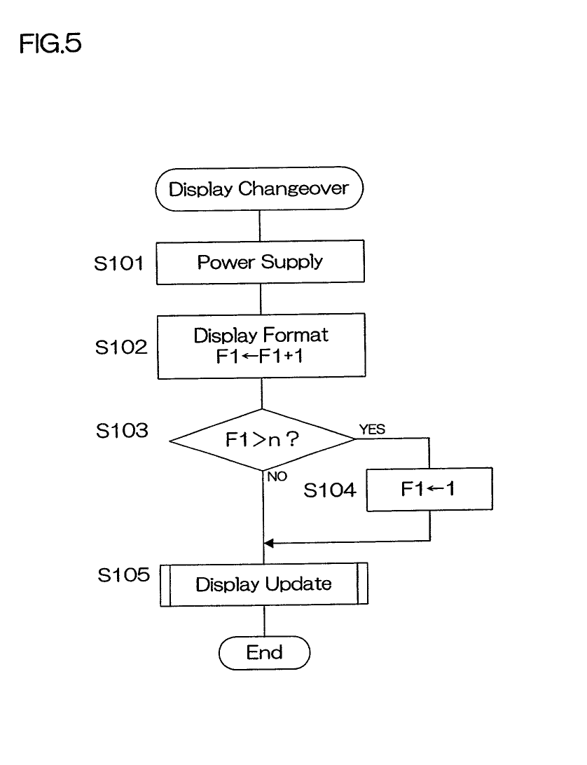

FIG. 4 is a block diagram of the circuit used commonly in both the IC card 1 and the mobile phone 5. The circuit comprises a central processing unit (CPU) 10, a display portion 11 corresponding to the display screens 2 and 6 shown in FIGS. 1 and 2, and a communication interface 12 for communication and input/output of various information between the portable device and an external device. The circuit is further provided with a first memory 13 for storing information relating to various functions, a second memory 14 for storing display formats F1, image memory 15, power source portion 16 for supplying power to various parts of the portable device and is connected to an AC power source or an installed battery, and a power controller 17 for controlling the ON/OFF state of the supplied power, and is still further provided with an operation portion 18 corresponding to the operation button 3 of FIG. 1 and the keys 7 of FIG. 2. The CPU 10 controls the display cooperatively with the image memory 15, and updates the information cooperatively with the communication portion 12.

The first memory 13 has a plurality of built-in memory chips or IC chips 20-1, 20-2, 20-3, 20-4, 20-5 for storing information relating to each function for each function separately. In the present embodiment, the first memory chip 20-1 stores digital cash information as information relating to a first function, the second memory chip 20-2 stores the points of a customer/member of a department store or the like as information relating to a second function, the third memory chip 20-3 stores employee information as information relating to a third function, the memory chip 20-4 stores commuter ticket information as information relating to a fourth function, and the memory chip 20-5 is empty and held in reserve. That is, the first through fourth memory chips 20-1, 20-1, 20-3, 20-4 store various types of information relating to the first through fourth four different functions separately for each function.

Among the four memory chips 20-1, 20-2, 20-3, 20-4, the memory content of at least the first, second, and fourth memory chips 20-1, 20-2, 20-4 are updateable with new information input from an external device through the communication portion 12.

That is, the employee information relating to the third function is not a content that is updated from an external device insofar as a particular circumstances does not require. The digital cash remainder balance and the member points relating to the first and second functions are information which are frequently, almost daily, updated and are information normally requiring confirmation of the update state by the owner of the portable device. The commuter ticket information relating to the fourth function is information normally updated about once in several months, and is information requiring infrequent confirmation of the update state by the owner of the portable device.

The second memory 14 has a plurality of built-in first, second, and third memory chips or IC chips 30-1, 30-2, 30-3; these memory chips differ from the memory chips of the first memory 13 in that they do not store external data, but rather store a plurality of variously customized formats F1, various types of programs P, and current selection format information. For example, various types of formats F1 are stored in the first memory chip 30-1, various types of programs P are stored in the second memory chip 30-2, and currently selected format information is stored in the third memory chip 30-3.

The operation portion 18 corresponds to the operation button 3 and the display selection key 7. The operation of pressing the operation button 3 and display selection button 7 to switch the displayed contents is referred to simply as a “display switching operation.”

The display portion 11 comprises a Chiral Nematic liquid crystal display having memory function, such that the display content is maintained even when the power source is turned OFF.

The power source portion 16 supplies power to each part of the circuit from the installed removable battery and/or the AC power source connected by a cable. The power controller 17 is constructed so as to turn ON the power supply to each part when communicating or operating, and automatically turn OFF the power supply to each part of the circuit in the regular state without communication or operation. The power supply even may be turned OFF only to the display portion 11; power conservation efficiency is high even when power is only turned OFF to the display portion 11.

The communication interface 12 performs communication between the portable device and an external device via various types of methods such as radio waves, cable, or reader as necessary, and is capable of inputting new information through the CPU 10 to the memory chips 20-1, 20-2, 20-3, 20-4 of the first memory 13, and sending the information stored in each memory chip 20-1, 20-2, 20-3, 20-4 to an external device. When communication starts, the communication interface 12 transmits an interrupt signal to the CPU 10.

The CPU 10 performs the display control and update functions as described above, and further executes the processing and controls of each part of the circuit. For example, required information and formats are called from memories 13 and 14, and a composite image is generated in accordance with specific programs, and controls are executes such as writing to the image memory 15 and the like. In the normal state, the sleep mode is entered, and interrupt signals are monitored from the communication interface 12 and operation portion 18.

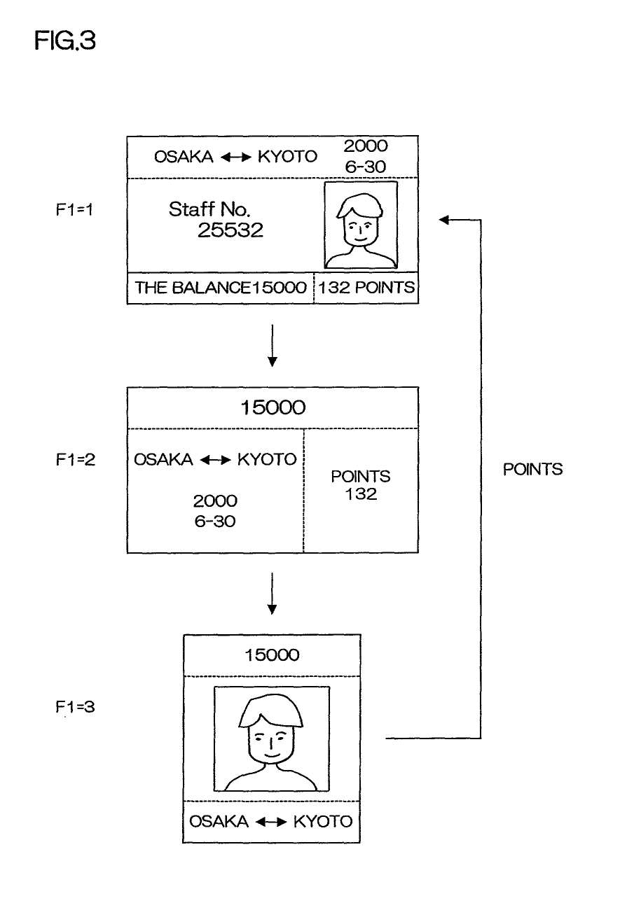

FIG. 3 shows examples of composite display screens in formats F1=1, 2, 3 when the display type is switched by the three types of formats.

The format F1=1 shown in the top level of FIG. 3 comprises a display screen divided into four sections; a first screen section includes the top area, a second screen section includes a large center area, a third screen section includes the left half of the bottom area, and the fourth screen section includes the right half of the bottom area. Each information relating to the four functions can be displayed in one of the screen sections. That is, the section and period of the commuter ticket is displayed in the first screen section, employee information including the staff number and photograph are displayed in the second screen section, the digital cash information including remaining balance is displayed in the third screen section, and the points of the department store member are shown in the fourth screen section.

The format F1=2 shown in the center level of FIG. 3 shows a display screen divided into three sections; the first screen section includes the top area, the second screen section includes the left half of the bottom area, and the third screen section includes the right half of the bottom area. Each information relating to the three functions is displayed in one of the screen sections. That is, only the numerical value of the digital cash balance is displayed in the first screen section, the section and period of the commuter ticket is shown in the second screen section, and the member points are displayed in the third screen section.

The format F1=3 shown in the bottom level of FIG. 3 shows a display screen divided into three section, top, middle, and bottom; the first screen section includes the top area, the second screen section includes the middle area, and the third screen section includes the bottom area. Each information relating to the three functions is displayed in one of the screen sections. That is, only the numerical value of the digital cash balance is displayed in the first screen section, only the photograph of the employee information is displayed in the second screen section, and only the section of the commuter ticket is displayed in the third screen section.

The format F1 and the display content are cyclically switched in the sequence “—(F1=1)—(F1=2)—(F1=3)—(F1=4)— . . . ”, as indicated by the arrows when the display switching operation is executed.

The control sequence is described below based on the flow charts.

FIG. 5 shows the sequence of the display switching control. Each time the display switching operation is performed, a display switch interrupt signal is input, and the routine shown in FIG. 5 is executed. In the drawing, n is the number of the stored format F1. According to the display switching operation, power is supplied to each part in step S101, and the content of the display format F1 is switched to the content of the format F1+1 in step S102. For example, the format is switched from format F1=2 to format F1=3. In step S103, a determination is made as to whether or not the value of the switched format F1 is greater than n. When the determination is NO, the routine advances to step S105 and the display is updated. For example, the display is switched to the display in format F1=3. On the other hand, when the determination is YES in step S103, the routine advances to step S104, and the display returns to format F1=1, then the routine advances to step S105, and the display is updated.

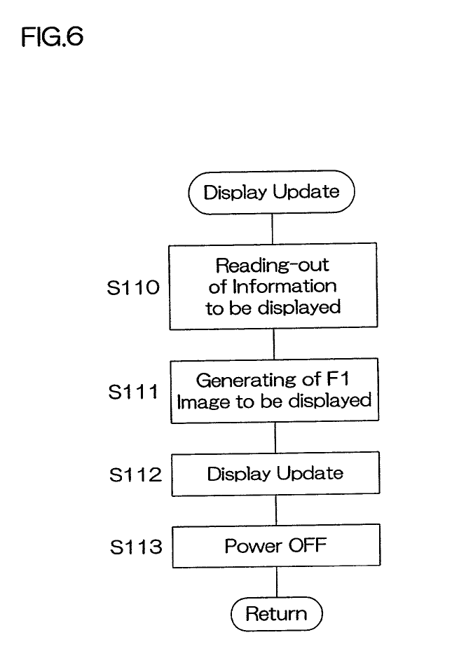

FIG. 6 shows the sequence of the display update in step S105 of FIG., 5. When display update is specified, in step S110 in FIG. 6, the function to be displayed in the current format F1 is selected from among the memory chips 20-1, 20-2, 20-3, 20-4 of the first memory 13 of FIG. 4, and the information of the required function is read out. In step S111, a display image is generated in accordance with the format F1. In step S112, the generated display image is recorded in the display memory 15 of FIG. 4, then the display content of the display portion 11 is updated. In step S113 in FIG. 6, when the power is turned OFF, the routine returns. Since the display portion 11 itself has memory function, the display content is maintained even after power is turned OFF.

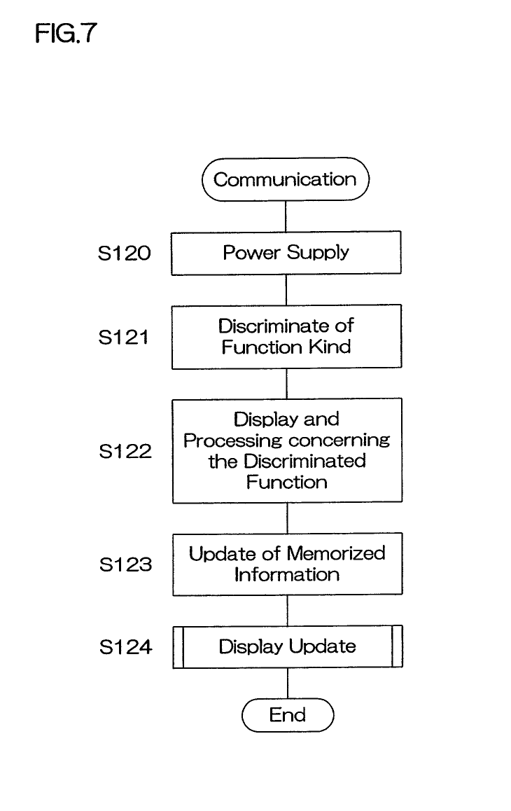

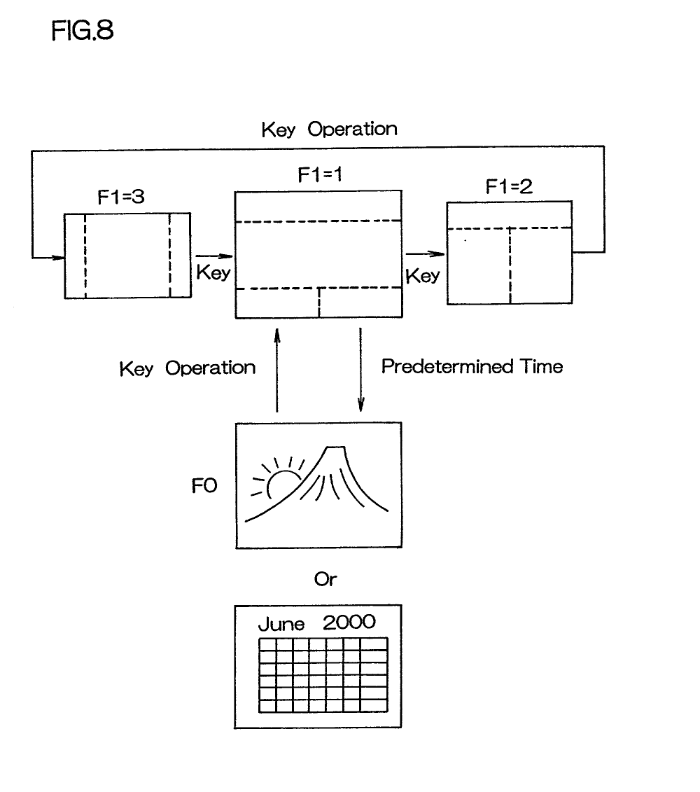

FIG. 7 shows the sequence of the communication control. When a communication interrupt signal is input, the routine shown in FIG. 7 is executed. First, in step S120 the power is turned ON, and in step S121 the function is determined from the initial communication content. That is, a determination is made as to whether or not the information relates to any function from among the first function (digital cash) through the fourth function (commuter ticket) stored within the first memory 13 of FIG. 4. Then, the routine advances to step S122 of FIG. 7, the display content relating to the discriminated function is modified, and various processes are executed in conjunction with the display content modification. For example, when it is digital cash information, the transaction history may be displayed in addition to the remaining balance. When it is phone card information, an abridged number also may be displayed. In step S123, the updated information is stored in the memory chip related to the function of the first memory 13 in FIG. 4, and the display is updated in step S124, and the routine ends.

FIG. 8 shows another embodiment of the present invention, and shows an example of a display in this embodiment. This embodiment provides, in addition to the structure of the previous embodiment, a structure for switching a specific standard screen F0 unrelated to a function with, for example, a landscape scene or calendar when a specific time, e.g., 30 min, has elapsed after display in format F1.

When an operator desires to view information relating to a function, the information may be displayed and confirmed in format F1 set by the display switching operation. In subsequent display switching operations, the display screen is switched in the sequence “—(F1=1)—(F1=2)—(F1=3)—(F1=4)— . . .”, similar to the previous embodiment shown in FIG. 3.

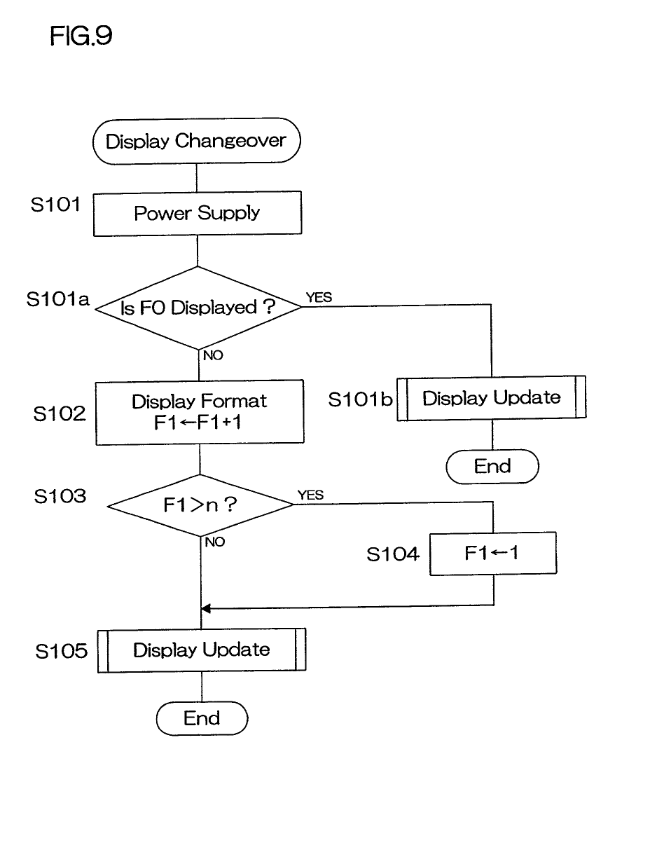

FIG. 9 is a flow chart of the display selection process, and adds a new step S101a to the flow chart of FIG. 5. Accordingly, the steps of the content have reference numbers identical to those of FIG. 5. In FIG. 9, a determination is made as to whether or not screen F0 is displayed in step S101a following step S101 in which power is supplied. When the determination is YES, the routine advances to step S101b and the display is updated to screen F1, then the routine ends. When the determination is NO in step S101a, the routine advances to step S102. Thereafter, processing is identical to that of FIG. 5.

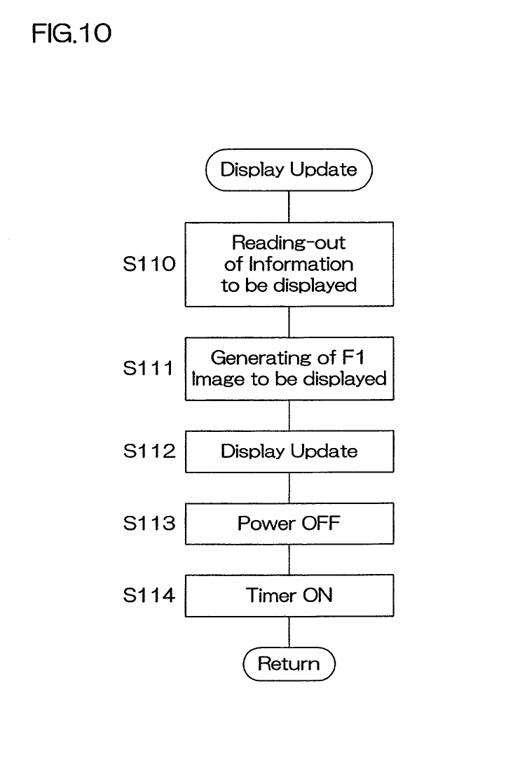

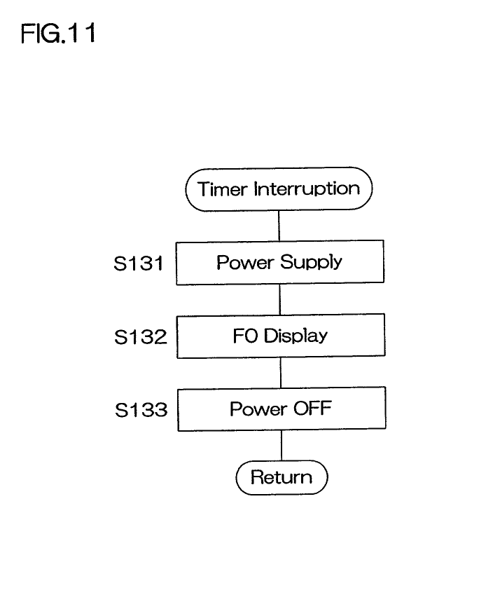

FIG. 10 shows a flow chart of the display update, and adds a new step S114 to the flow chart of FIG. 6. That is, when the power source is turned OFF in step S113, the routine advances to step S114 and a timer is automatically turned ON to start counting of a specific time, and the routine returns.

FIG. 11 shows the subroutine executed when the specific time counted by the timer has elapsed after the display update. That is, after the specified time has elapsed, a timer interrupt signal is input, and first, in step S131 power is supplied, in step S132 the F0 screen is displayed, and in step S133 the power is turned OFF, and the subroutine ends.

The present invention is not limited to the previously described embodiments, and may be produced using various modifications. For example, the constructions described below may be used.

(1) Although each embodiment has been described by way of examples in which formats of composite displays of information of a plurality of functions combined on a single display screen and a specific format is selected from among this group of formats, a specific format also may be selected from among a group of formats displaying information of a single function. In this case, a plurality of formats are selected which have different number of information, size, and position at which each information relating to a single function.

(2) It is possible to add new functions, and when a new function is added, the format group including this function may be cyclically selected.

(3) The structure may provide for modifying a format by time and date, or day of the week. For example, an after-working-hours format or holiday format may be generated.

(4) When a plurality of displays are used, e.g., an IC card having displays on front and back, a two side screen format may be generated, and distributed to each display.

Since, in the display devices applicable to portable devices such as IC cards and mobile phones described above, each information of each function is stored in memory, and the information of a plurality of functions is displayed simultaneously in a composite screen or information is displayed by selecting a format suitable for the function from among a plurality of formats, information of a variety of types of functions, and particularly including information of functions updating the display by communicaiton with an external device, may be easily confirmed simultaneously and in an optional display format in a single portable display device, thereby providing excellent portability, convenience, and operability.

Furthermore, since a display itself is provided with memory function, power can be conserved, and desirable function information may be normally viewed, which is very convenient in a portable device.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. A display device comprising:
a plurality of information memories for storing information relating to each type of function separately for each function, and including one or more memory updateable by information input via communication with an external device;
an updater for updating the information;
a display; and
a display controller for displaying composite images on the display based on a prescribed format and the information stored in the information memory.

2. A display device according to claim 1 further comprising:
a power source for supplying power to each part of the display device; and
a power controller for stopping power supply after a display operation by the display controller, wherein the display itself has a memory function.

3. A display device comprising:
a plurality of information memories for storing information relating to each type of function separately for each function, and including one or more memory updateable by information input via communication with an external device;
an updater for updating the information;
a display;
a format storage for storing a plurality of display formats specified by a user; and
a display controller for generating a display image based on current information and a selected display format, and displaying the image on the display.

4. A display device according to claim 3 further comprising:
a power source for supplying power to each part of the display device; and
a power controller for stopping power supply after a display operation by the display controller,
wherein the display itself has a memory function.

5. A portable device comprising:
a plurality of information memories for storing information relating to each type of function separately for each function, and including one or more memory updateable by information input via communication with an external device;
an updater for updating the information;
a display; and
a display controller for displaying composite images on the display based on a prescribed format and the information stored in the information memory.

6. A portable device according to claim 5 further comprising:
a power source for supplying power to each part of the portable device; and
a power controller for stopping power supply after a display operation by the display controller,
wherein the display itself has a memory function.

7. A portable device comprising:
a plurality of information memories for storing information relating to each type of function separately for each function, and including one or more memory updateable by information input via communication with an external device;
an updater for updating the information;
a display;
a format storage for storing a plurality of display formats specified by a user; and
a display controller for generating a display image based on current information and a selected display format, and displaying the image on the display.

8. A portable device according to claim 7 further comprising:
a power source for supplying power to each part of the portable device; and
a power controller for stopping power supply after a display operation by the display controller,
wherein the display itself has a memory function.
